(19) United States
(12) Patent Application Publication
(10) Pub. No.: US 2026/0005570 A1
(43) Pub. Date: Jan. 1, 2026

(54) CONTINUOUS COIL WINDING STRUCTURE FOR A STATOR

(71) Applicants: HYUNDAI MOTOR COMPANY, Seoul (KR); KIA CORPORATION, Seoul (KR)

(72) Inventors: Myung Hyun Kim, Hwaseong-si (KR); Won Jeong, Hwaseong-si (KR); Jae Eun Kim, Hwaseong-si (KR); Si Myung Jang, Hwaseong-si (KR)

(73) Assignees: HYUNDAI MOTOR COMPANY, Seoul (KR); KIA CORPORATION, Seoul (KR)

(21) Appl. No.: 18/982,729

(22) Filed: Dec. 16, 2024

(30) Foreign Application Priority Data
Jul. 1, 2024 (KR) 10-2024-0086009

(51) Int. Cl. H02K 3/28; H02K 1/16; H02K 3/12

(52) U.S. Cl. CPC H02K 3/28; H02K 1/16; H02K 3/12

(57) ABSTRACT

A continuous coil winding structure of a stator includes a stator core; slots located inside the stator core along an inner circumferential surface of the stator core; a plurality of layers located in the slots in a radial direction; and at least two continuous conductor bundles configured to be vertically alternately inserted into the plurality of layers. The at least two continuous conductor bundles each include a first end and a last end configured to be continuously electrically connected by connecting at least two divided conductor bundles.

### CROSS-REFERENCE TO RELATED APPLICATION

This application claims the benefit of and priority to Korean Patent Application No. 10-2024-0086009 filed on Jul. 1, 2024, the entire contents of which are incorporated herein by reference.

### TECHNICAL FIELD

The present disclosure relates to a continuous coil switching winding structure for a stator of an electric vehicle drive motor. More particularly, the present disclosure relates to a winding structure that utilizes continuous conductor bundles so that circulating current may be reduced through magnetomotive force balance design.

### BACKGROUND

A motor receives electrical energy and generates rotational force. Recently, research and development of motors that drive vehicles instead of engines have been actively conducted.

A motor includes a stator and a rotor. The rotor may rotate with respect to the stator by electromagnetic interaction between the stator and the rotor. For example, a coil may be wound on the stator, and a coil or a permanent magnet may be wound or provided on the rotor.

When current is applied to the coil of the stator and the stator becomes magnetized, the rotor may be rotated through interaction with the coil or the permanent magnet of the rotor.

The winding structure of the stator is important in generating a magnetic field required to operate the motor. This directly affects control of motor parameters, such as efficiency, power output, speed, and torque. Further, the winding structure of the stator affects heat dissipation, reliability, and durability.

Because the output of the motor is proportional to the number of turns of the coil wound on the stator, the coil winding structure of the stator is very important in the design of the motor. Accordingly, various winding methods are being considered. Based on the method known as hairpin winding, coils in the shape of individual hairpins with a square cross-section are inserted into slots provided in a stator, and the respective hairpin-shaped coils are welded to be wound on the stator. This method has the advantages of enabling relatively easy winding of the coils and increasing the filling factor of the coils to miniaturize a motor while enabling high output. However, in the case of the hairpin winding method, there are problems in that management and cost increase due to production of many types of hairpins, and it is difficult to implement and maintain the hairpin shape to increase coil insertability.

The above information disclosed in this Background section is only for enhancement of understanding of the background of the present disclosure and therefore the Background section may contain information that does not form the prior art that is already known in this country to a person of ordinary skill in the art.

### SUMMARY

The present disclosure has been made in an effort to solve the above-described problems associated with the prior art. An object of the present disclosure is to provide a coil winding structure that utilizes continuous conductor bundles so that circulating current may be reduced through magnetomotive force balance design. The continuous conductor bundle provides a structure in which the first end and the last end of the continuous conductive bundle are continuously connected by connecting divided conductor bundles to reduce a voltage drop.

The objects of the present disclosure are not limited to the above-mentioned objects, and other objects of the present disclosure that are not mentioned may be understood from the following description and may be more clearly understood by embodiments of the present disclosure. Further, the objects of the present disclosure may be realized by means and combinations thereof as indicated in the claims.

To achieve the above objects of the present disclosure, a continuous coil winding structure of a stator has the following configuration.

In an embodiment, the present disclosure provides a continuous coil winding structure of a stator including a stator core; slots located inside the stator core along an inner circumferential surface of the stator core; a plurality of layers located in the slots in a radial direction; and at least two continuous conductor bundles configured to be vertically alternately inserted into the plurality of layers. The at least two continuous conductor bundles each comprise a first end and a last end configured to be continuously electrically connected by connecting at least two divided conductor bundles.

In an embodiment, each of the at least two continuous conductor bundles may include linear parts configured to be inserted into the slots and may include end coil parts configured to connect the linear parts to each other.

In another embodiment, the end coil parts may include first end coils configured to connect first ends of adjacent linear parts and may include second end coils configured to connect second ends of the adjacent linear parts.

In still another embodiment, each of the at least two continuous conductor bundles may include lead-out parts including an input part and an output part.

In yet another embodiment, the end coil parts may include connection parts configured to electrically connect the at least two divided conductor bundles to each other.

In still yet another embodiment, the connection parts may be configured such that the at least two divided conductor bundles are directly connected to each other or are electrically connected through a separate conductor.

In a further embodiment, the at least two continuous conductor bundles may include a first continuous conductor bundle and a second continuous conductor bundle. When the lead-out parts of the first continuous conductor bundle and the lead-out parts of the second continuous conductor bundle are connected to the same external power supply so as to be electrically connected, the continuous coil winding structure may have a parallel structure.

In another further embodiment, when the output part of the first continuous conductor bundle and the input part of the second continuous conductor bundle are connected to each other so as to be electrically connected, the continuous coil winding structure may have a series structure.

In still another further embodiment, the plurality of layers may include 2N layers (N being a natural number) and may have a division structure of 2 layers, 3 layers, or 4 layers.

In yet another further embodiment, the at least two continuous conductor bundles may be inserted into the plurality of layers in a 7-5 pitch or 5-7 pitch structure.

Other aspects and embodiments of the present disclosure are discussed infra.

The above and other features of the present disclosure are discussed infra.

### BRIEF DESCRIPTION OF THE DRAWINGS

The above and other features of the present disclosure are described in detail with reference to certain embodiments thereof illustrated in the accompanying drawings, which are given for the purpose of illustration only and thus are not intended to limit the present disclosure, and wherein:

FIG. 1 is a perspective view of a stator core;

FIG. 2 is a side cross-sectional view of a continuous conductor bundle according to an embodiment of the present disclosure;

FIG. 3 is a perspective view of the stator core into which continuous conductor bundles are inserted, according to an embodiment of the present disclosure;

FIG. 4A illustrates a connection state between conductor bundles in a 4-layer/4-layer division structure according to an embodiment of the present disclosure;

FIG. 4B illustrates a parallel pattern of a 3-set division structure of the continuous conductor bundles in the 4 layer/4 layer division structure according to an embodiment of the present disclosure;

FIG. 5A illustrates a connection state between 4 sets of conductor bundles in the 4-layer/4-layer division structure according to an embodiment of the present disclosure;

FIG. 5B illustrates a parallel pattern of a 4-set division structure of the continuous conductor bundles in the 4 layer/4 layer division structure according to an embodiment of the present disclosure;

FIG. 6 illustrates a parallel pattern of a 2 layer/2 layer/2 layer/2 layer division structure according to an embodiment of the present disclosure;

FIG. 7 illustrates a parallel pattern of a 2 layer/4 layer/2 layer division structure according to an embodiment of the present disclosure;

FIG. 8 illustrates a parallel pattern of a 4 layer/2 layer division structure according to an embodiment of the present disclosure; and

FIG. 9 illustrates a parallel pattern of a 3 layer/3 layer division structure according to an embodiment of the present disclosure.

It should be understood that the appended drawings are not necessarily to scale and present a somewhat simplified representation of various features illustrating the basic principles of the present disclosure. The specific design features of the present disclosure as disclosed herein, including, for example, specific dimensions, orientations, locations, and shapes, may be determined in part by the particular intended application and use environment.

In the figures, same reference numbers refer to the same or equivalent parts of the present disclosure throughout the figures.

### DETAILED DESCRIPTION

Hereinafter, references are made in detail to various embodiments of the present disclosure, and the embodiments are illustrated in the accompanying drawings and described below. The present disclosure is not limited to the following embodiments, and the embodiments may be implemented in various different forms. The embodiments are provided to make the description of the present disclosure thorough and to fully convey the scope of the present disclosure to those having ordinary skill in the art.

Further, in the following description of the embodiments, it should be understood that the suffixes “ . . . part”, “ . . . unit”, etc. indicate units for processing at least one function or operation, and may be implemented as software, hardware, or a combination of software and hardware. When a controller, module, component, device, element, part, unit or the like of the present disclosure is described as having a purpose or performing an operation, function, or the like, the controller, module, component, device, element, part, unit, or the like should be considered herein as being “configured to” meet that purpose or to perform that operation or function. Each controller, module, component, device, element, part, unit, and the like may separately embody or be included with a processor and a memory, such as a non-transitory computer readable media, as part of the apparatus.

Further, the terminology used herein is for the purpose of describing particular embodiments only and is not intended to be limiting. As used herein, singular expressions may be intended to include plural expressions as well, unless the context clearly indicates otherwise.

In addition, in the following description of the present disclosure, when a part is said to “include” a component, the term “include” does not mean that other components are excluded unless otherwise specifically stated. Instead, other components may be included. Also, the term such as “ . . . part” described herein means units for processing at least one function or operation.

Hereinafter, the embodiments are described in detail with reference to the accompanying drawings. When the embodiments are described with reference to the accompanying drawings, identical or corresponding components are indicated by the same reference numerals and a redundant description thereof has been omitted.

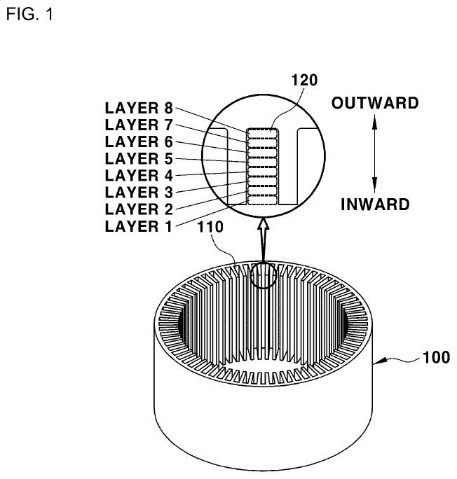

FIG. 1 is a perspective view of a stator core according to the present disclosure.

According to an embodiment of the present disclosure, a stator core 100 may include slots 110. Coil windings are inserted into the slots 110. The coil windings are core components of electric motors and generators and generate a magnetic field when current flows. More specifically, the coil windings may comprise continuous conductor bundles 200.

Furthermore, the slots 110 may be formed along the inner circumferential surface of the stator core 100. In other words, a plurality of slots 110 may be arranged at regular intervals along the inner circumferential surface of the stator core 100. More specifically, the stator core 100 of the present disclosure may include 48 slots 110.

In addition, a number written before the slot 110 in the following descriptions refers to the slot number used to distinguish one slot from another. Further, a plurality of layers 120 may be formed radially toward the center of the stator core 110 in the slot 110, and continuous conductor bundles 200 may be inserted into the plurality of layers 120. The plurality of layers 120 may be divided to have a 2-part, 3-part, or 4-part division structure. Further, the layers 120 in each slot 110 may be formed to have a structure in which the layers 120 are stacked in a direction from the inside of the stator core 100 to the outside of the stator core 100. More specifically, in the case of 8 layers 120, the layer 120 closest to the center of the stator core 100 corresponds to layer 1, and the layer 120 closest to the outer circumferential surface of the stator core 100 corresponds to layer 8.

In addition, a number written after the layer 120 disclosed in the following description means a layer number.

Further, the output of a motor depends on the number of turns of the continuous conductor bundles 200 wound on the stator core 100. The number of turns refers to the number of times that, after the continuous conductor bundle 200 is inserted into a layer 120 formed in a slot 110, the continuous conductor bundle 200 passes through the corresponding slot 110 and is then inserted into a layer 120 formed in another slot 110. For example, the continuous conductor bundle 200 may be inserted into layer 8 of slot 1, may pass through slot 1, and may be inserted into layer 7 of slot 8, and in this case, the number of turns is 1. Further, the number of turns is proportional to the number of the layers 120 in the slots 110 and the number of the slots 110. In other words, if other conditions are the same, when the number of the layers 120 increases, the number of turns may increase, and ultimately, the output of the motor may increase.

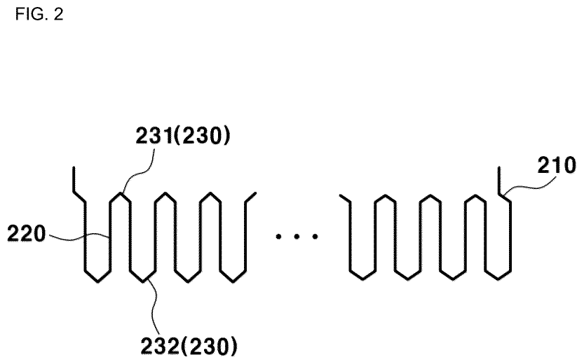

FIG. 2 is a side cross-sectional view of the continuous conductor bundle 200.

According to an embodiment of the present disclosure, the continuous conductor bundles 200 are manufactured using a continuous winding technique so that circulating current may be reduced through magnetomotive force balance design. Furthermore, the continuous conductor bundles 200 according to the present disclosure may be designed to have a reduced voltage drop compared to coil windings using the conventional continuous winding technique through connection of divided conductor bundles 210. In other words, the continuous conductor bundle 200 according to the present disclosure is configured such that a first end and a last end of the continuous conductor bundle 200 are continuously connected by connecting at least two divided conductor bundles 210.

More specifically, the ends of the at least two divided conductor bundles 210 may be directly connected by welding. If the at least two divided conductor bundles 210 are spaced apart from each other by a predetermined distance, the at least two divided conductor bundles may be connected through a bus bar. Thus, the continuous conductor bundle 200 may be formed.

The continuous conductor bundle 200 formed by connecting the divided conductor bundles 210 includes linear parts 220 inserted into the slots 110, and end coil parts 230, which connect neighboring linear parts 220. Further, the end coil parts 230 are configured to alternately connect both ends of the neighboring linear parts 220. For this purpose, the end coil parts 230 may include first end coils 231, which connect first ends of the linear parts 220, and may include second end coils 232, which connect second ends of the linear parts 220. More specifically, in an embodiment of the present disclosure, the first ends indicate the upper ends of the linear parts 220, and the second ends indicate the lower ends of the linear parts 220. Further, the end coil parts 230 may include connection parts 250, which electrically connect the divided conductor bundles 210.

In addition, a plurality of continuous conductor bundles 200 may be provided to form a multi-phase motor and to provide a series or parallel structure between the continuous conductor bundles 200. Furthermore, the continuous conductor bundles 20 may include a first continuous conductor bundle and a second continuous conductor bundle. More specifically, the first continuous conductor bundle may indicate a continuous conductor bundle U1, and the second continuous conductor bundle may indicate a continuous conductor bundle U2.

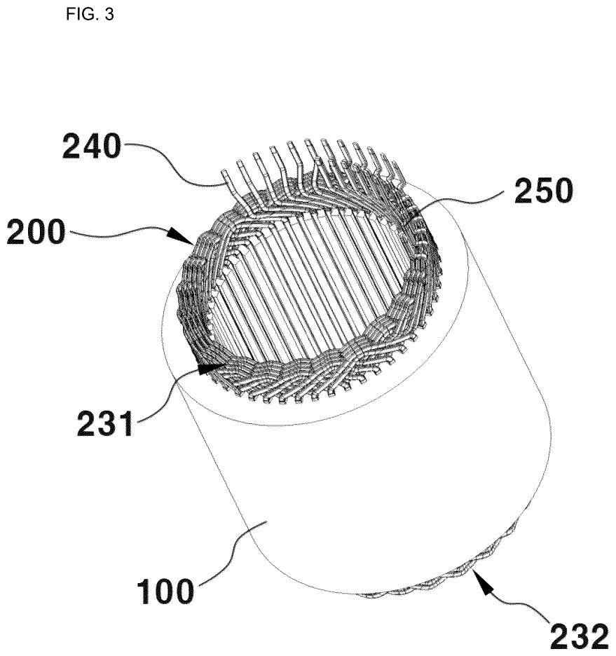

FIG. 3 is a perspective view of the stator core 100, into which the continuous conductor bundles 200 are inserted, according to an embodiment of the present disclosure.

According to an embodiment of the present disclosure, the present disclosure includes the plurality of slots 110 formed in the stator core 100, the plurality of layers 120 formed in the slots 110. The continuous conductor bundles 200 inserted into the plurality of layers 120 to form a magnetic field when current flows thereto. Furthermore, the continuous conductor bundles 200 may include lead-out parts 240 provided to be electrically connected to an inverter power supply or to electrical connect the continuous conductor bundles 200. In addition, the continuous conductor bundle 200 may include the end coil parts 230, and the end coil parts 230 may include the first end coils 231, which connect the upper ends of the linear parts 220, and may include the second end coils 232, which connect the lower ends of the linear parts 220. Furthermore, the end coil parts 230 may include the connection parts 250, which connect the divided conductor bundles 210. Further, the lead-out parts 240 may include an input part and an output part provided to be electrically connected to an external power supply or to electrically connect the continuous conductor bundles 200.

In addition, the winding structure of the continuous conductor bundles 200 is configured to have a series structure if the output part of the first continuous conductor bundle and the input part of the second continuous conductor bundle are electrically connected. More specifically, if the output part of the first continuous conductor bundle and the input part of the second continuous conductor bundle are adjacent to each other, the first and second continuous conductor bundles may be directly connected through welding. If the output part of the first continuous conductor bundle and the input part of the second continuous conductor bundle are spaced apart from each other by a designated distance, the first and second continuous conductor bundles may be directly connected through a bus bar. Further, if the winding structure of the continuous conductor bundles 200 has a series structure, the input part of the first continuous conductor bundle and the output part of the second continuous conductor bundle may be continuously electrically connected and may be connected to the input terminal and the output terminal of the external power supply, respectively. More specifically, the input part of the first continuous conductor bundle may be connected to the input terminal of the external power supply, and the output part of the second continuous conductor bundle may be connected to the output terminal of the external power supply.

Further, the winding structure of the continuous conductor bundles 200 is configured to have a parallel structure if the lead-out parts 240 of the first continuous conductor bundle and the lead-out parts 240 of the second continuous conductor bundle are connected to the external power supply to be electrically connected thereto. More specifically, the external power supply may indicate a power supply in a terminal box or an inverter. The winding structure of the continuous conductor bundles 200 may be configured to have a parallel structure if the input part of the first continuous conductor bundle and the input part of the second continuous conductor bundle are connected to the same phase input power supply in the terminal box or the inverter.

In addition, the number of the slots 110, the number of the layers 120, the width and length of the slots 110, a space between the slots 110, the number of poles, and the number of turns may be changed based on the purpose of a corresponding motor. For example, the present disclosure may provide a stator core 100 of a three-phase motor 8, which includes 48 slots 110 and 8 layers 120 in each slot 110 and forms 8 poles. Further, the present disclosure may provide winding structures of various combinations through division of the 8 layers 120 in each slot 110. More specifically, the 8 layers 120 may have a 2 layer/2 layer/2 layer/2 layer division structure, a 4 layer/4 layer division structure, or a 2 layer/4 layer/2 layer division structure.

Further, the continuous conductor bundles 200 may pass through the slots 110 through the upper or lower portions of the layers 120 formed in the slots 110, and the length of the linear parts 220 of the continuous conductor bundles 200 may be changed depending on the height of the slots 11. In addition, the continuous conductor bundles 200 may be alternately inserted into the plurality of layers 120. More specifically, the continuous conductor bundles 200 may be inserted into the layers 120 in a 7-5 pitch pattern to avoid interference between the continuous conductor bundles 200. In addition, the continuous conductor bundles 200 may be inserted into the layers 120 in a 6-6 pitch structure based on the purpose and efficiency.

Guides may be installed between the respective slots 110 to minimize damage during a process of inserting the continuous conductor bundles 200 into the layers 120. The respective guides may be removed after insertion of all the continuous conductor bundles 200 has been completed.

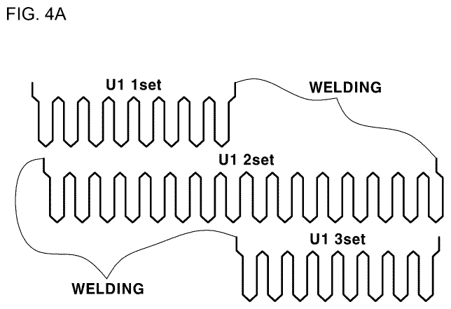

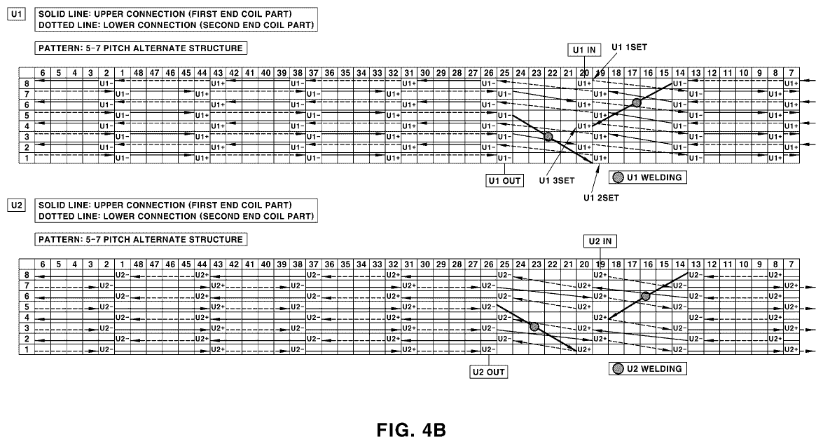

FIG. 4A illustrates a connection state between conductor bundles 210 in a 4 layer/4 layer division structure.

According to an embodiment of the present disclosure, a continuous conductor bundle 200, i.e., a continuous conductor bundle U1, is formed by connecting conductor bundles 210, i.e., conductor bundles U1 1SET, U1 2SET, and U1 3SET. Thus, the continuous conductor bundle U1 may be formed. More specifically, the other end of the conductor bundle U1 1SET and the other end of the conductor bundle U1 2SET may be electrically connected through welding, and one end of the conductor bundle U1 2SET and one end of the conductor bundle U1 3SET may be electrically connected through welding. Further, if direct welding is not possible, the conductor bundles U1 1SET, U1 2SET, and U1 3SET may be connected through a separate conductor, e.g., a bus bar. The continuous conductor bundle U1 may be formed in this manner, and another continuous conductor bundle U2 may also be formed in the same manner.

In addition, in winding patterns shown in FIGS. 4-9, only one phase U among three phases U, V, and W, or one phase U including two parallel circuits U1 and U2 is illustrated. Further, the continuous conductor bundle U2 shown in FIGS. 4-9 may be configured to have a similar winding structure to the continuous conductor bundle U1 and may be disposed in an adjacent slot 110 to have a parallel structure of the same phase. Moreover, the winding structures of continuous conductor bundles 200 of the V phase and the W phase may be configured to have the same pattern and the same number of turns as the winding structure of the continuous conductor bundles 200 of the U phase illustrated in an embodiment of the present disclosure. Further, the winding structures of the continuous conductor bundles 200 of the V phase and the W phase may be configured to have a series structure or a parallel structure in the same manner as the winding structure of the continuous conductor bundles 200 of the U phase.

In addition, the flow of arrows in the patterns shown in FIGS. 4-9 indicates the flow of current, and in this case, the flow of solid arrows indicates the flow of current through the first end coils 231, and the flow of dotted arrows indicates the flow of current through the second end coils 232. More specifically, a solid line may indicate the flow of current through upper connection of the continuous conductor bundles 200, and a dotted line may indicate the flow of current through lower connection of the continuous conductor bundles 200.

FIG. 4B illustrates a parallel pattern of the 3-set division structure of the continuous conductor bundles 200 in the 4 layer/4 layer division structure.

According to an embodiment of the present disclosure, the illustrated example shows a 2-parallel structure with 48 slots, 8 poles, and 8 layers. In the illustrated pattern, the continuous conductor bundle U1 is formed by connecting the conductor bundles 210, i.e., the conductor bundles U1 1SET, U1 2SET, and U1 3SET. Further, one end of the continuous conductor bundle U1 is connected to a part of the power supply of the inverter so that the power of the U phase comes into the continuous conductor bundle U1, and the other end of the continuous conductor bundle U1 is connected to another part of the power supply of the inverter so that circulating current flows out of the continuous conductor bundle U1. More specifically, the power of the U phase may come into the continuous conductor bundle U1 through the conductor bundle U1 1SET, and the circulating current of the U phase may flow to the inverter through the conductor bundle U1 3SET.

In addition, the conductor bundle U1 2SET of the continuous conductor bundle U1 may be configured to be twice the number of turns of the conductor bundles U1 1SET and U1 3SET. Further, when the continuous conductor bundle U1 is inserted into the plurality of layers 120 formed in the slot 110, the conductor bundle U1 1SET is inserted before the conductor bundle U1 2SET, and the conductor bundle U1 3SET is inserted after the middle turn of the conductor bundle U1 2SET. Thus, winding of the continuous conductor bundle 200 through mechanical insertion thereof into the slot 110 is completed.

Furthermore, in the case of the U-phase 2-parallel structure, the continuous conductor bundle U2 may be inserted into a slot 110 adjacent to the continuous conductor bundle U1 and may be inserted into the same slot 110 while overlapping with the continuous conductor bundle U1. More specifically, the continuous conductor bundle U2 may be inserted into layers 120 into which the continuous conductor bundle U1 is not inserted, in the slot 110 into which the continuous conductor bundle U1 is inserted. For example, the continuous conductor bundle U1 may be inserted into layers 1, 3, 5, and 7 in slot 19, and the continuous conductor bundle U2 may be inserted into layers 2, 4, 6, and 8 in slot 19.

Moreover, in order to avoid interference between the conductor bundles U1 1SET and U2 1SET, the conductor bundle U1 1SET may be inserted in a 7-5 pitch pattern, and the conductor bundle U2 1SET may be inserted in a 5-7 pitch structure. More specifically, the conductor bundle U1 1SET may be formed in the 7-5 pitch pattern to be inserted into slots 20, 13, and 8, and the conductor bundle U2 1SET may be formed in the 5-7 pitch structure to be inserted into slots 19, 14, and 7. On the other hand, the conductor bundle U2 1SET may be formed in the 7-5 pitch pattern, and the conductor bundle U1 1SET may be formed in the 5-7 pitch structure. Otherwise, the conductor bundles U1 1SET and U2 1SET may be formed to have a 6-6 pitch structure.

According to an embodiment of the present disclosure, the continuous conductor bundle U1 is configured such that the conductor bundle U1 1SET is inserted into layers 5 to 8, the conductor bundle U1 3SET is inserted into layers 1 to 4, and the conductor bundle U1 2SET is inserted into layers 1 to 8.

Referring to the current flow in the illustrated pattern, the power of the U phase is applied through the input part of the continuous conductor bundle U1, i.e., the conductor bundle U1 1SET, located at the upper portion of layer 8 of slot 20, and the applied current flows in the inward direction of the core, i.e., in the direction of the arrow, through the continuous conductor bundle 200 inserted into layer 8 of slot 20. The current applied to layer 8 of slot 20 flows toward layer 7 of slot 13. Then, the current applied to layer 7 of slot 13 flows in the direction of the arrows toward layer 6 of slot 20 through layers 7 of slots 8, 1, 44, 37, 32, and 25. Further, the current applied to the layer 6 of sot 20 is applied to one end of the conductor bundle U1 2SET located at the upper portion of layer 1 of slot 19 through layers 5 of slots 13, 8, 1, 44, 37, 32, and 25.

The current applied to one end of the conductor bundle U1 flows in the outward direction of the core through layers 2 of slots 26, 31, 38, 43, 2, 7 and 14 in the direction of the arrows. Then, the current applied to layer 2 of slot 14 flows toward layers 4 of slots 26, 31, 38, 43, 2, 7, and 14 through layer 3 of slot 19 in the direction of the arrows. Further, the current applied to layer 4 of slot 14 flows toward layers 6 of slots 26, 31, 38, 43, 2, 7, and 14 through layer 5 of slot 19. Moreover, the current applied to layer 6 of slot 14 flows toward the layers 8 of slots 26, 31, 38, 43, 2, 7, and 14 in the direction of the arrows through layer 7 of slot 19. The current applied to layer 8 of slot 14 is applied to one end of the conductor bundle U1 3SET located at the upper portion of layer 4 of slot 20.

The current applied to one end of the conductor bundle U1 3SET flows in the inward direction of the core through layer 3 of slot 13 in the inner circumferential surface of the conductor bundle U1 3SET. Then, the current applied to layer 3 of slot 13 flows toward layer 2 of slot 20 through layers 3 of slots 8, 1, 44, 37, 32, and 25. Further, the current applied to layer 2 of slot 20 is applied to the other end of the conductor bundle U1 3SET of the continuous conductor bundle 200, located at the upper portion of layer 1 of slot 25, through layers 1 of slots 13, 8, 1, 44, 37, 32, and 25. The other end of the conductor bundle U1 3SET may be connected to a part of the inverter power supply and may serve as an OUT terminal through which the current having circulated through the continuous conductor bundle U1 is discharged. Therefore, the circulating current flows toward the output part of the continuous conductor bundle U1, i.e., the conductor bundle U1 3SET.

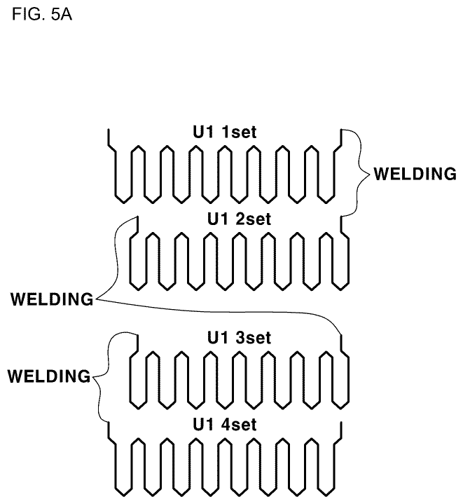

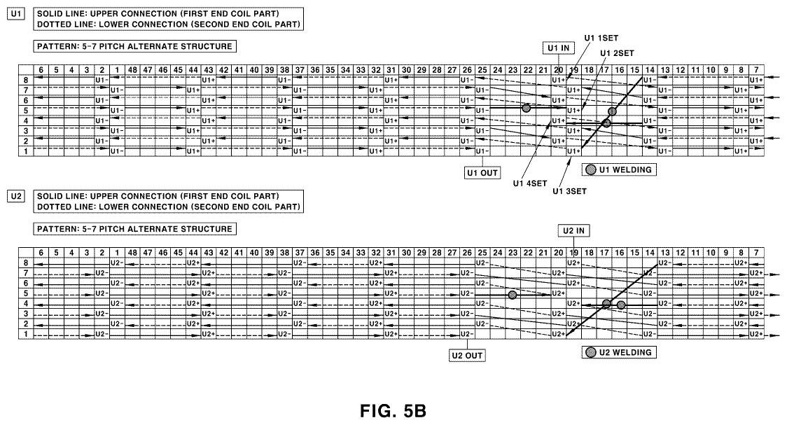

FIG. 5A illustrates a connection state between 4 sets of conductor bundles 210 in the 4-layer/4-layer division structure according to an embodiment of the present disclosure.

According to another embodiment of the present disclosure, a continuous conductor bundle 200, i.e., a continuous conductor bundle U1, is formed by connecting conductor bundles 210, i.e., conductor bundles U1 1SET, U1 2SET, U1 3SET, and U1 4SET. More specifically, the continuous conductor bundle U1 may be configured such that the other end of the conductor bundle U1 1SET and the other end of the conductor bundle U1 2SET are connected through welding, one end of the conductor bundle U1 2SET and the other end of the conductor bundle U1 3SET are connected through welding, and one end of the conductor bundle U1 3SET and one end of the conductor bundle U1 4SET are connected.

FIG. 5B illustrates a parallel pattern of the 4-set division structure of the continuous conductor bundles 200 in the 4 layer/4 layer division structure.

According to another embodiment of the present disclosure, the illustrated example shows a 2-parallel structure with 48 slots, 8 poles, and 8 layers, the plurality of layers is divided into 4 layers and 4 layers, and the continuous conductor bundle 200 is inserted into the divided layers. More specifically, the plurality of layers is divided into layers 1 to 4 and layers 5 to 8, and the conductor bundles U1 1SET and U1 2SET may be inserted into layers 5 to 8 and the conductor bundles U1 3SET and U1 4SET may be inserted into layers 1 to 4. Further, the continuous conductor bundle 200 may be formed by connecting the conductor bundles U1 1SET, U1 2SET, U1 3SET, and U1 4SET.

Referring to the current flow in the illustrated pattern, the power of the U phase is applied through the input part of the continuous conductor bundle U1, i.e., the conductor bundle U1 1SET, located at the upper portion of layer 8 of slot 20, and the applied current flows in the inward direction of the core through layers 7 of slots 13, 8, 1, 44, 37, 32, and 25. Then, the current flows toward layers 5 of slots 13, 8, 1, 44, 37, 32, and 25 through layer 6 of slot 20. The current applied to layer 5 of slot 25 is applied to the other end of the conductor bundle U1 2SET located at the upper portion of layer 5 of slot 19.

Further, the current applied to the other end of the conductor bundle U1 2SET flows in the outward direction of the core through layers 6 of slots 26, 31, 38, 43, 2, 7, and 14. Then, the current applied to layer 6 of slot 14 flows toward layers 8 of slots 26, 31, 38, 43, 2, 7, and 14 through layer 7 of slot 19. The current applied to layer 8 of slot 14 is applied to the other end of the conductor bundle U1 3SET located at the upper portion of layer 1 of slot 19.

Further, the applied current flows in the outward direction of the core. At this time, the current passes through layers 2 of slots 26, 31, 38, 43, 2, 7, and 14, passes through layer 3 of slot 19, and then flows toward layers 4 of slots 26, 31, 38, 43, 2, 7, and 14. The current applied to layer 4 of slot 14 is applied to one end of the conductor bundle U1 4SET located at the upper portion of layer 4 of slot 20.

At this time, the applied current flows in the inward direction of the core and, more specifically, passes through layers 3 of slots 13, 8, 1, 44, 37, 32, and 25, passes through layer 2 of slot 20, and is applied to the other end of the conductor bundle U1 4SET through layers 1 of slots 13, 8, 1, 44, 37, 32, and 25. The other end of the conductor bundle U1 4SET is connected to a part of the inverter power supply. Accordingly, the circulating current may flow to the inverter through the output part of the continuous conductor bundle U1, i.e., the other end of the conductor bundle U1 4SET.

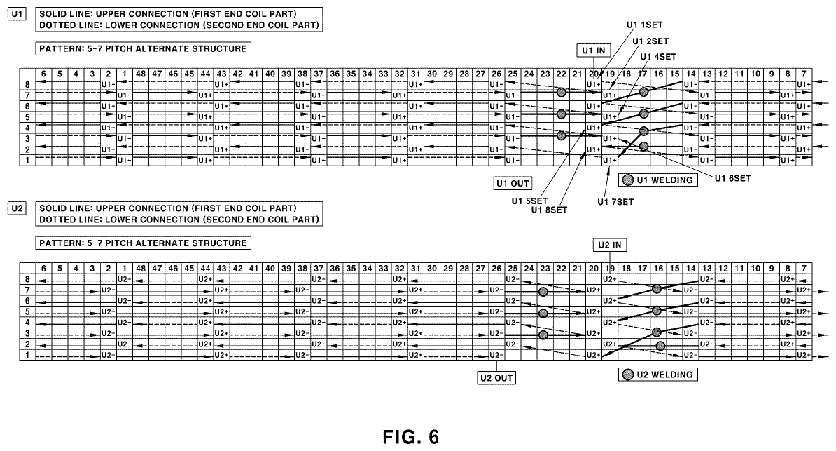

FIG. 6 illustrates a parallel pattern of a 2 layer/2 layer/2 layer/2 layer division structure.

According to another embodiment of the present disclosure, 8 sets of divided conductor bundles 210 are inserted into layers 1 to 8, and a continuous conductor bundle U1 is formed by connecting the 8 sets of divided conductor bundles 210. More specifically, the conductor bundles U1 1SET and U1 2SET may be inserted into layers 7 and 8, the conductor bundles U1 3SET and U1 4SET may be inserted into layers 5 and 6, the conductor bundles U1 5SET and U1 6SET may be inserted into layers 3 and 4, and the conductor bundles U1 7SET and U1 8SET may be inserted into layers 1 and 2.

In this case, in the current flow in the illustrated pattern, the power for the continuous conductor bundle U1 is applied to one end of the conductor bundle U1 1SET located at the upper portion of layer 8 of slot 20. The applied current flows in the inward direction of the core through the layers 7 of slots 13, 8, 1, 44, 37, 32, and 25, and is applied to the conductor bundle U1 2SET located at the upper portion of layer 7 of slot 19.

Further, the applied current flows in the outward direction of the core through layers 8 of slots 26, 31, 38, 43, 2, 7, and 14, and is applied to the conductor bundle U1 3SET located at the upper portion of layer 6 of slot 20.

Moreover, the applied current is applied to the conductor bundle U1 4SET through layers 5 of slots 13, 8, 1, 44, 37, 32, and 25 in the inward direction of the core.

Then, the current flows in the outward direction of the core through layers 6 of slots 26, 31, 38, 43, 2, 7, and 14 and is applied to the conductor bundle U1 5SET located at the upper portion of layer 4 of slot 20. Thus, the applied current is applied to the conductor bundle U1 6SET located at the upper portion of layer 3 of slot 19 through layers 3 of slots 13, 8, 1, 44, 37, 32, and 25.

The current applied to the conductor bundle U1 6SET flows in the outward direction of the core through layers 4 of slots 26, 31, 38, 43, 2, 7, and 14, passes through the conductor bundle U1 7SET located at the upper portion of layer 1 of slot 19, and flows in the outward direction of the core toward layers 2 of slots 26, 31, 38, 43, 2, 7, and 14. Finally, the current applied to layer 2 of slot 14 is applied to the conductor bundle U1 8SET located at the upper portion of layer 2 of slot 20 and flows in the inward direction of the core toward layers 1 of slot 13, 8, 1, 44, 37, 32, and 25. The conductor bundle U1 8SET is connected to a part of the inverter power supply, and the circulating current flows to the inverter through the conductor bundle U1 8SET.

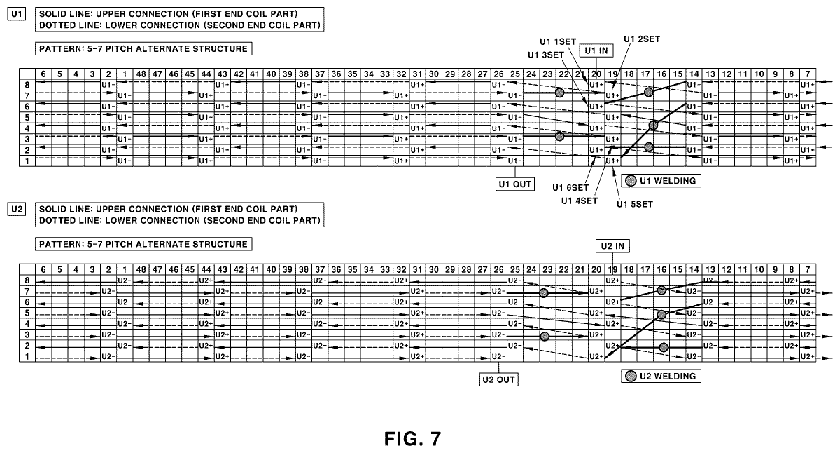

FIG. 7 illustrates a parallel pattern of a 2 layer/4 layer/2 layer division structure.

According to another embodiment of the present disclosure, 8 layers are divided into 2 layers, 4 layers, and 2 layers, and 6 sets of divided conductor bundles 210 are inserted into layers 1 to 8, and a continuous conductor bundle 200 is formed by connecting the 6 sets of divided conductor bundles 210. More specifically, the conductor bundles U1 1SET and U1 2SET may be inserted into layers 7 and 8, the conductor bundles U1 3SET and U1 4SET may be inserted into layers 3 to 6, and the conductor bundles U1 5SET and U1 6SET may be inserted into layers 1 and 2.

In the current flow in the illustrated pattern according to this embodiment, the current is applied to the conductor bundle U1 1SET located at the upper portion of layer 8 of slot 20, and the applied current flows in the inward direction of the core through the layers 7 of slots 13, 8, 1, 44, 37, 32, and 25, is applied to the conductor bundle U1 2SET located at the upper portion of layer 7 of slot 19, and then flows in the outward direction of the core toward layers 8 of slots 26, 31, 38, 43, 2, 7, and 14.

Thereafter, the current is applied to the conductor bundle U1 3SET located at the upper portion of layer 6 of slot 20, passes through layers 5 of slots 13, 8, 1, 44, 37, 32, and 25 in the inward direction of the core, passes through layer 4 of slot 20, flows to layers 3 of slots 13, 8, 1, 44, 37, 32, and 25, and is applied to the conductor bundle U1 4SET.

Thereafter, the current flows in the outward direction of the core and, more specifically, passes through layers 4 of slots 26, 31, 38, 43, 2, 7, and 14, passes through layer 5 of slot 19, and flows to layers 6 of slots 26, 31, 38, 43, 2, 7, and 14.

Further, the current applied to the conductor bundle U1 5SET through layer 6 of slot 14 passes through layer 1 of slot 19, flows in the outward direction of the core toward layers 2 of slots 26, 31, 38, 43, 2, 7, and 14, and is applied to the conductor bundle U1 6SET. Finally, the current applied to the conductor bundle U1 6SET flows in the inward direction of the core toward layers 1 of slot 13, 8, 1, 44, 37, 32, and 25, and then the current flows to the inverter through the conductor bundle U1 6SET.

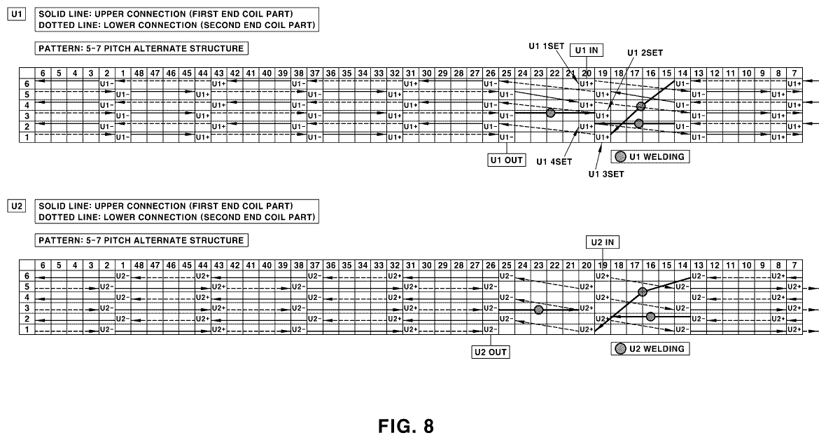

FIG. 8 illustrates a parallel pattern of a 4 layer/2 layer division structure.

According to another embodiment of the present disclosure, in a stator core 100 having a 48-slot 8-pole 6-layer structure, 6 layers are divided into 3 layers and 3 layers. Further, 4 sets of divided conductor bundles 210 are inserted into layers 1 to 6, and a continuous conductor bundle 200 is formed by connecting the 4 sets of divided conductor bundles 210. More specifically, the conductor bundles U1 1SET and U1 2SET may be inserted into layers 3 to 6, and the conductor bundles U1 3SET and U1 4SET may be inserted into layers 1 and 2.

In the current flow in the illustrated pattern, if the power is applied to the conductor bundle U1 1SET located at the upper portion of layer 6 of slot 20, the applied current flows in the inward direction of the core to layers 5 of slots 13, 8, 1, 44, 37, 32, and 25, passes through layer 4 of slot 20, flows in the inward direction of the core to layers 3 of slots 13, 8, 1, 44, 37, 32, and 25, and then flows to the conductor bundle U1 2SET located in layer 3 of slot 19. Then, the current flows in the outward direction of the core to layers 4 of slots 26, 31, 38, 43, 2, 7, and 14, passes through layer 5 of slot 19, and flows to layers 6 of slots 26, 31, 38, 43, 2, 7, and 14. Further, the current flows to the conductor bundle U1 3SET located in layer 1 of slot 19, and flows in the outward direction of the core to layers 2 of slots 26, 31, 38, 43, 2, 7, and 14. Finally, the current flows to the conductor bundle U1 4SET located in layer 2 of slot 20 and flows to the inverter through layers 1 of slots 13, 8, 1, 44, 37, 32, and 25.

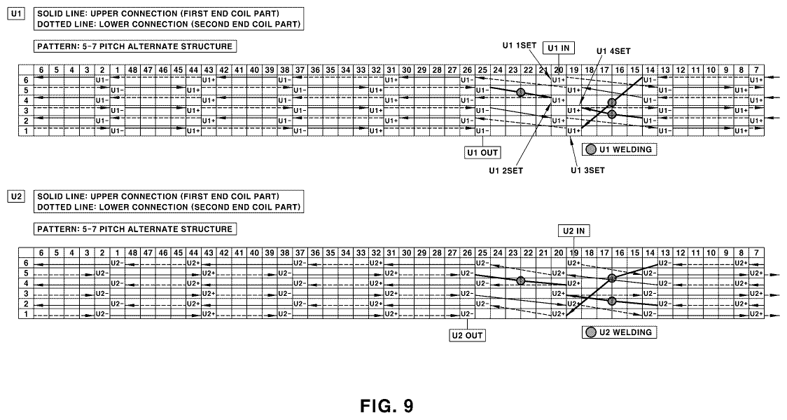

FIG. 9 illustrates a parallel pattern of a 3 layer/3 layer division structure.

According to another embodiment of the present disclosure, in a stator core 100 having a 48-slot 8-pole 6-layer structure, 6 layers are divided into 4 layers and 2 layers. Further, 4 sets of divided conductor bundles 210 are inserted into layers 1 to 6, and a continuous conductor bundle 200 is formed by connecting the 4 sets of divided conductor bundles 210. More specifically, the conductor bundles U1 1SET and U1 2SET may be inserted into layers 4 to 6, and the conductor bundles U1 3SET and U1 4SET may be inserted into layers 1 to 3.

In this case, in the current flow in the illustrated pattern, the power for the continuous conductor bundle U1 is applied to the conductor bundle U1 1SET located in layer 6 of slot 20, and the applied current flows in the inward direction of the core through layers 5 of slots 13, 8, 1, 44, 37, 32, and 25.

Then, the current is applied to the conductor bundle U1 2SET located in layer 6 of slot 20, flows in the outward direction of the core through layers 4 of slots 26, 31, 38, 43, 2, 7, and 14, passes through layer 5 of slot 19, and flows to layers 6 of slots 26, 31, 38, 43, 2, 7, and 14.

Further, the current applied to layer 6 of slot 14 is applied to the conductor bundle U1 3SET, flows in the outward direction of the core through layers 2 of slots 26, 31, 38, 43, 2, 7, and 14, and is applied to the conductor bundle U1 4SET located in layer 3 of slot 19.

The current applied to the conductor bundle U1 4SET flows in the inward direction of the core through layers 3 of slots 13, 8, 1, 44, 37, 32, and 25, passes through layer 2 of slot 20, and finally flows to layers 1 of slots 13, 8, 1, 44, 37, 32, and 25. Further, the conductor bundle U1 4SET is connected to the inverter, and the circulating current flows to the inverter through the conductor bundle U1 4SET.

As apparent from the above descriptions, the present disclosure may obtain the following effects through the above-described configuration, combination, and usage relations disclosed in the embodiments.

First, the present disclosure may obtain the effect of reducing the number of types of conventionally used coils by utilizing continuous conductor bundles.

Second, the present disclosure may obtain the effect of reducing voltage stress in slots through divided conductor bundles.

Third, the present disclosure may obtain the effect of increasing insulation stability by reducing the voltage stress within the slots.

The above detailed descriptions illustrate the present disclosure. In addition, the above descriptions illustrate embodiments of the present disclosure, and the present disclosure may be used in various other combinations, modifications, and environments. In other words, changes or modifications are possible within the spirit and scope of the present disclosure, the scope equivalent to the disclosure, and/or the scope of technology or knowledge in the art. The described embodiments illustrate a mode for implementing the technical idea of the present disclosure, and various changes required for specific application fields and uses of the present disclosure are also possible. Therefore, the detailed description of the disclosure above is not intended to limit the present disclosure to the disclosed embodiments. In addition, the appended claims should be interpreted to include other embodiments.

What is claimed is:

1. A continuous coil winding structure of a stator comprising:
a stator core;
slots located inside the stator core along an inner circumferential surface of the stator core;
a plurality of layers located in the slots in a radial direction; and
at least two continuous conductor bundles configured to be vertically alternately inserted into the plurality of layers,
wherein the at least two continuous conductor bundles each comprise a first end and a last end configured to be continuously electrically connected by connecting at least two divided conductor bundles.

2. The continuous coil winding structure of claim 1, wherein each of the at least two continuous conductor bundles comprises:
linear parts configured to be inserted into the slots; and
end coil parts configured to connect the linear parts to each other.

3. The continuous coil winding structure of claim 2, wherein the end coil parts comprise:
first end coils configured to connect first ends of adjacent linear parts; and
second end coils configured to connect second ends of the adjacent linear parts.

4. The continuous coil winding structure of claim 1, wherein each of the at least two continuous conductor bundles comprises lead-out parts comprising an input part and an output part.

5. The continuous coil winding structure of claim 2, wherein the end coil parts comprise connection parts configured to electrically connect the at least two divided conductor bundles to each other.

6. The continuous coil winding structure of claim 5, wherein the connection parts are configured such that the at least two divided conductor bundles are directly connected to each other or are electrically connected through a separate conductor.

7. The continuous coil winding structure of claim 4, wherein the at least two continuous conductor bundles comprise a first continuous conductor bundle and a second continuous conductor bundle, and
wherein, when the lead-out parts of the first continuous conductor bundle and the lead-out parts of the second continuous conductor bundle are connected to the same external power supply so as to be electrically connected, the continuous coil winding structure has a parallel structure.

8. The continuous coil winding structure of claim 7, wherein, when the output part of the first continuous conductor bundle and the input part of the second continuous conductor bundle are connected to each other so as to be electrically connected, the continuous coil winding structure has a series structure.

9. The continuous coil winding structure of claim 1, wherein the plurality of layers comprises 2N layers (N being a natural number) and has a division structure of 2 layers, 3 layers, or 4 layers.

10. The continuous coil winding structure of claim 1, wherein the at least two continuous conductor bundles are configured to be inserted into the plurality of layers in a 7-5 pitch or 5-7 pitch pattern.
